(19) United States
(12) Patent Application Publication
(10) Pub. No.: US 2024/0039042 A1
(43) Pub. Date: Feb. 1, 2024

(54) SOLID ELECTROLYTE FOR SOLID-STATE BATTERY AND METHOD FOR PREPARING THE SAME

(71) Applicants: LG ENERGY SOLUTION, LTD., Seoul (KR); TOKYO INSTITUTE OF TECHNOLOGY, Tokyo (JP)

(72) Inventors: Eiichiro NARIMATSU, Kanagawa (JP); Hideyuki MAEDA, Kanagawa (JP); Keiko MATSUBARA, Kanagawa (JP); Ryoji KANNO, Tokyo (JP); Satoshi HORI, Daejeon (JP)

(21) Appl. No.: 18/268,007

(22) PCT Filed: Apr. 29, 2022
(86) PCT No.: PCT/KR2022/006218

§ 371 Date: Jun. 16, 2023

(30) Foreign Application Priority Data
Apr. 30, 2021 (JP) 2021-077607

(51) Int. Cl. H01M 10/0562; H01M 10/052

(52) U.S. Cl. CPC H01M 10/0562; H01M 10/052; H01M 2300/0068

(57) ABSTRACT

Disclosed is a solid electrolyte for a solid-state battery having improved water resistance. The solid electrolyte for a solid-state battery includes a sulfide-based solid electrolyte and a LiBr-containing absorbent material, wherein the binding energy of Li1s shows a peak observed at 54.2-56.1 eV, and the binding energy of Br3d shows a peak observed at 67.5-69.5 eV, as determined by X-ray photoelectron spectroscopy (XPS).

### CROSS-REFERENCE TO RELATED APPLICATIONS

This application is a National Phase entry pursuant to 35 U.S.C. § 371 of International Application No. PCT/KR2022/006218, filed on Apr. 29, 2022, and claims the benefit of and priority to Japanese Patent Application No. 2021-077607, filed on Apr. 30, 2021, the disclosures of which are incorporated by reference in their entirety for all purposes as if fully set forth herein.

### TECHNICAL FIELD

The present disclosure relates to a solid electrolyte for a solid-state battery and a method for preparing the same.

### BACKGROUND

Development of solid-state batteries using a solid electrolyte substituting for a liquid electrolyte of lithium-ion batteries has been conducted in order to provide batteries with high safety, long service life and high energy density. Among many types of solid electrolytes, a sulfide-based solid electrolyte, such as Li₁₀GeP₂S₁₂, has high ion conductivity close to the ion conductivity of a liquid electrolyte and is soft, and thus is advantageous in that it is easy to obtain close adhesive property to an active material. Therefore, commercialization of solid-state batteries using a sulfide-based solid electrolyte has been expected.

However, such a sulfide-based solid electrolyte generally has low water resistance and reacts with water in the air to generate harmful hydrogen sulfide (H₂S). Therefore, in order to obtain a solid-state lithium-ion battery by using a sulfide-based solid electrolyte, an ultralow-dew point environment, such as a dew point of −80° C., is required. For this, H₂S may be generated in the conventional lithium-ion battery manufacturing environment of a dew point of approximately −45° C. to cause a safety-related problem.

In Patent Document 1, the composition of a compound having an Argyrodite-type crystal structure and represented by the chemical formula of Li_{7-x-2y}PS_{6-x-y}Clₓ (wherein 0.8≤x≤1.7, 0<y≤−0.25x+0.5) is disclosed. The compound shows water resistance by inhibiting its reactivity with water. However, since the compositional spectrum of a sulfide-based solid electrolyte is limited, there is a problem in that precise control is required to accomplish such a limited composition.

Therefore, there is a need for improving the water resistance of a sulfide-based solid electrolyte so that the sulfide-based solid electrolyte may be prepared safely even under the dew point environment of the conventional lithium-ion battery manufacturing process.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### REFERENCES

Patent Document 1: Japanese Laid-Open Patent No. 2016-024874

### DISCLOSURE

### Technical Problem

The present disclosure is designed to solve the problems of the related art, and therefore the present disclosure is directed to providing a solid electrolyte for a solid-state battery which has improved water resistance.

### Technical Solution

In one aspect of the present disclosure, there is provided a solid electrolyte for a solid-state battery, including a sulfide-based solid electrolyte and a LiBr-containing absorbent material, wherein a binding energy of Li1s shows a peak observed at 54.2-56.1 eV, and a binding energy of Br3d shows a peak observed at 67.5-69.5 eV, as determined by X-ray photoelectron spectroscopy (XPS).

According to an embodiment, a ratio of a peak count number of Br3d to a peak count number of Li1s (Br3d peak count number/Li1s peak count number) may be 0.3 or more.

According to another embodiment, the sulfide-based solid electrolyte may have a LiGePS type crystal structure.

According to still another embodiment, a ratio of an intensity of a peak of LiBr present at 2θ=32.6° to an intensity of a peak of LiGePS type crystal present at 2θ=29.3° (LiBr peak (2θ=32.6°) intensity/LiGePS type crystal peak (2θ=29.3°) intensity) may be 0.02 or more, as determined by XRD.

According to yet another embodiment, a lattice volume (V) of the solid electrolyte for a solid-state battery and a lattice volume (V₀) of the sulfide-based solid electrolyte may satisfy a relationship of 0.5≤{(V−V₀)/V₀}×100.

In another aspect, there is provided a method for preparing a solid electrolyte for a solid-state battery, including the steps of: mixing a sulfide-based solid electrolyte with an absorbent material to obtain a mixture; and heat treating the mixture, wherein a heat treatment temperature (T[° C.]) and a melting point (Tₘ[° C.]) of the absorbent material satisfy a relationship of T≥Tₘ−60.

According to an embodiment, the absorbent material may include LiBr.

According to another embodiment, the method may further include a step of adding the absorbent material after the heat treatment step.

### Advantageous Effects

The present disclosure can provide a solid electrolyte for a solid-state battery which has improved water resistance. Since the solid electrolyte for a solid-state battery includes an absorbent material capable of reacting with water to form stable hydrate, it is possible to improve the water resistance of the solid electrolyte for a solid-state battery with no limitation in the type and composition of the sulfide-based solid electrolyte.

### DESCRIPTION OF DRAWINGS

FIG. 1 shows the spectrum of each of Examples 1-4, Comparative Example 1 and LiBr powder, as analyzed by X-ray photoelectron spectroscopy (XPS).

FIG. 2 shows the pattern image of Example 1, as determined by X-ray diffractometry.

FIG. 3 shows the enlarged XRD pattern of each of Examples 1-4 and Comparative Example 1.

FIG. 4 is a graph illustrating the generation of H₂S from the crude powder according to each of Examples and Comparative Example at a dew point of −30° C., depending on exposure time.

FIG. 5 is a graph illustrating the generation of H₂S from the powder of ≤10 μm according to each of Examples and Comparative Example at a dew point of −30° C., depending on exposure time.

FIG. 6 is a graph illustrating the generation of H₂S from the powder of ≤10 μm according to each of Examples and Comparative Example at a dew point of −45° C., depending on exposure time.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

[Solid Electrolyte for Solid-State Battery]

The solid electrolyte for a solid-state battery according to the present disclosure includes a sulfide-based solid electrolyte and an absorbent material. The solid electrolyte for a solid-state battery may further include additives, such as a lithium salt, a conductive material, a binder resin, or the like, depending on the particular use.

<Sulfide-Based Solid Electrolyte>

The sulfide-based solid electrolyte is not particularly limited, as long as it contains sulfur (S), and any known sulfide-based solid electrolyte may be used.

The sulfide-based solid electrolyte may have a crystal structure. The sulfide-based solid electrolyte may have a NASICON type, perovskite type, garnet type, LiGePS type or argyrodite type crystal structure.

The sulfide-based solid electrolyte may contain Li, X and S, wherein X may include P, Ge, B, Si, Sn, As, Al, Zr, Ga, V, Nb, Sb, Ti, Cl, F, I, O, N, or two or more of them.

Preferably, the sulfide-based solid electrolyte may have a LiGePS type crystal structure. The LiGePS type crystal structure can receive an absorbent material in the form of a solid solution into the crystal structure through the heat treatment with the absorbent material. When the solid electrolyte for a solid-state battery is exposed to water, the absorbent material received in the solid electrolyte in the form of a solid solution reacts with water to form hydrate, thereby inhibiting generation of H₂S and improving the water resistance of the solid electrolyte for a solid-state battery.

The sulfide-based solid electrolyte may be amorphous, vitreous or glass-ceramic.

The sulfide-based solid electrolyte may have metal that belongs to Group 1 or Group 2 in the Periodic Table, and may include Li—P—S type glass or Li—P—S type glass-ceramic. Non-limiting examples of the sulfide-based solid electrolyte may include at least one selected from Li₂S—P₂S₅, Li₂S—LiI—P₂S₅, Li₂S—LiI—Li₂O—P₂Ss, Li₂S—LiBr—P₂S₅, Li₂S—Li₂O—P₂Ss, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, and Li₂S—GeS₂—ZnS.

<Absorbent Material>

The absorbent material may be any known material, as long as it is a material capable of absorbing water. Preferably, the absorbent material may include lithium bromide (LiBr). When LiBr is contained in a solid electrolyte for a solid-state battery, it may not adversely affect the ion conductivity of the solid electrolyte for a solid-state battery.

The absorbent material may be present in an amount of 0.1-10 wt %, preferably 0.5-8 wt %, more preferably 1-6 wt %, and most preferably 2-5 wt %, based on the total weight of the solid electrolyte for a solid-state battery. When the content of the absorbent material falls within the above-defined range, it is possible to inhibit H₂S generation and to improve the water resistance of the solid electrolyte for a solid-state battery. As described hereinafter, an absorbent material may be further added subsequently to the solid electrolyte for a solid-state battery containing the absorbent material.

The absorbent material may be present on the surface and/or inside of the sulfide-based solid electrolyte. When the absorbent material is present stably on the surface and/or in the crystal lattice of the sulfide-based solid electrolyte, it does not adversely affect the ion conductivity of the solid electrolyte for a solid-state battery, even after forming hydrate through the reaction with water, and it allows retention of the ion conductivity of the solid electrolyte for a solid-state battery, even after the solid electrolyte is exposed to water.

[XRS Peak]

When the absorbent material includes LiBr, peaks derived from the binding energy of Li1s and Br3d are detected in the X-ray photoelectron spectroscopy (XPS) of the solid electrolyte for a solid-state battery. In the solid electrolyte for a solid-state battery according to the present disclosure, LiBr as an absorbent material may be present on the surface and/or inside of the sulfide-based solid electrolyte. For this reason, there are cases where the solid electrolyte for a solid-state battery shows a binding energy different from the binding energy of each of Li1s and Br3d detected in the XPS analysis of pure LiBr powder. As shown in Table 2, pure LiBr powder show a binding energy of Li1s and that of Br3d of 56.19 eV and 68.69 eV, respectively.

<Binding Energy>

In the solid electrolyte for a solid-state battery according to the present disclosure, the binding energy of Li1s shows a peak observed at 54.2-56.1 eV, preferably 54.5-55.8 eV, more preferably 54.8-55.5 eV, and most preferably 55.1-55.3 eV. It is to be noted that the binding energy of Li1s in the solid electrolyte for a solid-state battery according to the present disclosure is different from the binding energy of Li1s peak of pure LiBr powder. It is thought that such a difference in binding energy of Li1s peak results from the presence of LiBr as an absorbent material on the surface and/or inside of the sulfide-based solid electrolyte in the solid electrolyte for a solid-state battery according to the present disclosure.

In the solid electrolyte for a solid-state battery according to the present disclosure, the binding energy of Br3d shows a peak observed at 67.5-69.5 eV, preferably 67.8-69.2 eV, more preferably 68.1-68.9 eV, and most preferably 68.4-68.6 eV.

When the binding energy of Li1s and that of Br3d fall within the above-defined ranges, the absorbent material, LiBr, may be present stably on the surface and/or inside of the sulfide-based solid electrolyte. In the solid electrolyte for a solid-state battery, LiBr present stably therein reacts with water to form hydrate, thereby inhibiting H₂S generation and improving the water resistance of the solid electrolyte for a solid-state battery.

<Ratio of Count Number>

The ratio of the peak count number of Br3d to the peak count number of Li1s (Br3d/Li1s) may be 0.3 or more, preferably 1-10, more preferably 2-8, and most preferably 2.9-6.

When the ratio of count number falls within the above-defined range, LiBr contained in the solid electrolyte for a solid-state battery reacts with water to form hydrate, thereby inhibiting H₂S generation and improving the water resistance of the solid electrolyte for a solid-state battery.

[X-Ray Diffractometry (XRD)]

In XRD analysis, the ratio of the intensity of the peak of LiBr present at 2θ=32.6° to the intensity of the peak of LiGePS type crystal present at 2θ=29.3° (LiBr peak (2θ=32.6°) intensity/LiGePS type crystal peak (2θ=29.30) intensity) may be 0.02 or more, preferably 0.03-0.15, more preferably 0.035-0.10. The sulfide-based solid electrolyte of LiGePS type crystal may be Li₁₀SnP₂S₁₂. The peak of LiBr present at 2θ=32.6° may be a peak corresponding to (2, 0, 0) surface of LiBr, and the peak of LiGePS type crystal present at 2θ=29.3° may be a peak corresponding to (2, 0, 3) surface of LiGePS type crystal.

When the ratio of peak intensity falls within the above-defined range, LiBr contained in the solid electrolyte for a solid-state battery may be present stably in the form of crystals and reacts with water to form hydrate, thereby inhibiting H₂S generation and improving the water resistance of the solid electrolyte for a solid-state battery.

The value of 2θ in XRD may vary with a measurement error, or the like. According to the present disclosure, a specific value of 2θ may be interpreted as a range of [specific value of 2θ±0.1°]. For example, ‘the intensity of the peak of LiBr present at 2θ=32.6° ’ may be interpreted as the intensity of the peak of LiBr detected at 32.5-32.7°.

[Lattice Volume]

The lattice volume of the solid electrolyte for a solid-state battery may be increased by introducing the absorbent material into the lattice of the sulfide-based solid electrolyte.

The lattice volume (V) of the solid electrolyte for a solid-state battery and the lattice volume (V₀) of the sulfide-based solid electrolyte satisfy the relationship of 0.5≤{(V−V₀)/V₀}×100, preferably 0.65≤{(V−V₀)/V₀}×100, more preferably 1.0≤{(V−V₀)/V₀}×100, and most preferably 1.3≤{(V−V₀)/V₀}×100. Herein, {(V−V₀)/V₀}×100 may be 5.0 or less, 2.5 or less, or 2.0 or less.

When the relationship falls within the above-defined range, LiBr contained in the solid electrolyte for a solid-state battery may react with water to form hydrate, thereby inhibiting H₂S generation and improving the water resistance of the solid electrolyte for a solid-state battery.

[Heat Treatment Temperature]

The solid electrolyte for a solid-state battery is obtained by the method including the steps of: mixing a sulfide-based solid electrolyte with an absorbent material to obtain a mixture; and heat treating the mixture, wherein the heat treatment temperature (T[° C.]) and the melting point (Tₘ[° C.]) of the absorbent material satisfy the relationship of T≥Tₘ−60. The heat treatment temperature may be a temperature where the ingredients contained in the solid electrolyte for a solid-state battery are not thermally decomposed.

Since the heat treatment temperature is close to the melting point of the absorbent material, interdiffusion is accelerated even in the case of a solid-state absorbent material, and thus the absorbent material is present on the surface and/or inside of the sulfide-based solid electrolyte. When the heat treatment temperature is higher than the melting point of the absorbent material, the absorbent material is present in a liquid state and has flowability, and thus is received in the form of a solid solution with ease in the crystal lattice of the sulfide-based solid electrolyte. Therefore, the lattice volume of the solid electrolyte for a solid-state battery according to the present disclosure becomes larger than the lattice volume of the sulfide-based solid electrolyte in which the absorbent material is not received in the state of a solid solution.

The heat treatment temperature (T[° C.]) and the melting point (Tₘ[° C.]) of the absorbent material satisfy the relationship of T≥Tₘ−60, preferably Tₘ+60≥T≥Tₘ−60, and more preferably Tₘ+50≥T≥Tₘ−50.

The heat treatment temperature (T[° C.]) may satisfy T≥490° C., preferably 610° C.≥T≥490° C., and more preferably 600° C.≥T≥550° C.

When the heat treatment temperature (T[° C.]) and the melting point (Tₘ[° C.]) of the absorbent material satisfy the above-defined range, mixing of the sulfide-based solid electrolyte with the absorbent material is accelerated, and thus the absorbent material is present on the surface and/or inside of the sulfide-based solid electrolyte. Therefore, the absorbent material contained in the solid electrolyte for a solid-state battery may react with water to form hydrate, thereby inhibiting H₂S generation and improving the water resistance of the solid electrolyte for a solid-state battery.

The step of mixing the sulfide-based solid electrolyte with the absorbent material to obtain a mixture and the step of heat treating the mixture may be carried out under inert atmosphere. Herein, ‘inert atmosphere’ means atmosphere filled with a known inert gas, such as argon gas or nitrogen gas.

The step of mixing the sulfide-based solid electrolyte with the absorbent material to obtain a mixture may include a step of forming the sulfide-based solid electrolyte from a raw material of sulfide-based solid electrolyte. The raw material of sulfide-based solid electrolyte may be any known material for forming a sulfide-based solid electrolyte.

[Addition of Absorbent Material]

After mixing the sulfide-based solid electrolyte with the absorbent material and heat treating the resultant mixture, a step of adding an absorbent material to the solid electrolyte for a solid-state battery may be further carried out.

The absorbent material may be added in an amount of 0.1-10 wt %, preferably 0.5-8 wt %, more preferably 1-6 wt %, and most preferably 2-5 wt %, based on the total weight of the solid electrolyte for a solid-state battery. In other words, the sum of the absorbent material contained in the solid electrolyte for a solid-state battery and the absorbent material added subsequently may be 0.2-20 wt %, preferably 1-16 wt %, more preferably 2-12 wt %, and most preferably 4-10 wt %, based on the total weight of the solid electrolyte for a solid-state battery.

When adding the absorbent material after heat treating the solid electrolyte for a solid-state battery, the absorbent material contained in the solid electrolyte for a solid-state battery may be increased, thereby inhibiting H₂S generation and improving the water resistance of the solid electrolyte for a solid-state battery.

[Solid-State Battery]

The electrolyte for a solid-state battery according to the present disclosure may be used for a solid-state battery including a positive electrode, a negative electrode and a solid electrolyte membrane. The solid electrolyte for a solid-state battery may be used as an ingredient of the solid electrolyte membrane. The solid electrolyte for a solid-state battery may be used together with the active material in the electrode active material layer of each of the positive electrode and the negative electrode. The electrolyte for a solid-state battery may have an average particle diameter controlled depending on the particular use.

<Solid Electrolyte Membrane>

According to the present disclosure, the solid electrolyte membrane may have a thickness of about 50 μm or less, preferably about 15-50 μm. The solid electrolyte membrane may have a suitable thickness considering the ion conductivity, physical strength, energy density of an applicable battery, or the like. For example, in terms of the ion conductivity or energy density, the thickness may be 10 μm or more, 20 μm or more, or 30 μm or more. Meanwhile, in terms of the physical strength, the thickness may be 50 μm or less, 45 μm or less, or 40 μm or less. In addition, while the solid electrolyte membrane has the above-defined range of thickness, it may have a tensile strength of about 100-2,000 kgf/cm². Further, the solid electrolyte membrane may have a porosity of 15 vol % or less, or about 10 vol % or less. Thus, even though the solid electrolyte membrane according to the present disclosure is a thin film, it may have high mechanical strength.

<Positive Electrode and Negative Electrode>

According to the present disclosure, each of the positive electrode and the negative electrode includes a current collector, and an electrode active material layer formed on at least one surface of the current collector, wherein the electrode active material layer includes a plurality of electrode active material particles and a solid electrolyte. If necessary, the electrode may further include at least one of a conductive material and a binder resin. Additionally, the electrode may further include various additives in order to supplement or improve the physical/chemical properties of the electrode.

According to the present disclosure, the negative electrode active material may be any material, as long as it can be used as a negative electrode active material for a lithium-ion secondary battery. Particular examples of the negative electrode active material include any one selected from: carbon such as non-graphitizable carbon or graphite-based carbon; metal composite oxides, such as LiₓFe₂O₃ (0≤x≤1), LiₓWO₂ (0≤x≤1), SnₓMe₁₋ₓMe′_{y}O_{z} (Me: Mn, Fe, Pb, Ge; Me′: Al, B, P, Si, elements of Group 1, 2 or 3 in the Periodic Table, halogen; 0<x≤1; 1≤y≤3; 1≤z≤8); lithium metal; lithium alloy; silicon-based alloy; indium metal; indium alloy; tin-based alloy; metal oxides, such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄ and Bi₂O₅; conductive polymers, such as polyacetylene; Li—Co—Ni type materials; and titanium oxide; or a mixture of two or more of them. According to an embodiment of the present disclosure, the negative electrode active material may include a carbonaceous material and/or Si.

In the case of the positive electrode, the electrode active material may be any material with no particular limitation, as long as it can be used as a positive electrode active material for a lithium-ion secondary battery. For example, the positive electrode active material may include any one selected from: layered compounds, such as lithium cobalt oxide (LiCoO₂) and lithium nickel oxide (LiNiO₂), or those compounds substituted with one or more transition metals; lithium manganese oxides such as those represented by the chemical formula of Li₁₊ₓMn₂₋ₓO₄ (wherein x is 0-0.33), LiMnO₃, LiMn₂O₃ and LiMnO₂; lithium copper oxide (Li₂CuO₂); vanadium oxides such as LiV₃O₈, LiV₃O₄, V₂O₅ or Cu₂V₂O₇; Ni-site type lithium nickel oxides represented by the chemical formula of LiNi₁₋ₓMₓO₂ (wherein M is Co, Mn, Al, Cu, Fe, Mg, B or Ga, and x is 0.01-0.3); lithium manganese composite oxides represented by the chemical formula of LiMn₂₋ₓMₓO₂ (wherein M is Co, Ni, Fe, Cr, Zn or Ta, and x is 0.01-0.1) or Li₂Mn₃MOs (wherein M is Fe, Co, Ni, Cu or Zn); lithium manganese composite oxides having a spinel structure and represented by the formula of LiNiₓMn₂₋ₓO₄; NCM-based composite oxides represented by the chemical formula of Li(NiₐCo_{b}Mn_{c})O₂ (wherein each of a, b and c represents the atomic fraction of an independent element, 0<a<1, 0<b<1, 0<c<1, and a+b+c=1); LiMn₂O₄ in which Li is partially substituted with an alkaline earth metal ion; disulfide compounds; Fe₂(MoO₄)₃; or the like. However, the scope of the present disclosure is not limited thereto.

According to the present disclosure, the current collector may be selected from the current collectors, such as metal plates, having electrical conductivity and known in the field of secondary batteries, depending on the polarity of the electrode.

According to the present disclosure, the conductive material is added generally in an amount of 1-30 wt % based on the total weight of the mixture including the electrode active material. The conductive material is not particularly limited, as long as it causes no chemical change in the corresponding battery and has conductivity. For example, the conductive material include any one selected from: graphite, such as natural graphite or artificial graphite; carbon black, such as acetylene black, Ketjen black, channel black, furnace black, lamp black or thermal black; conductive fibers, such as carbon fibers or metallic fibers; carbon fluoride; metal powder, such as aluminum or nickel powder; conductive whisker, such as zinc oxide or potassium titanate; conductive metal oxide, such as titanium oxide; and conductive materials, such as polyphenylene derivatives, or a mixture of two or more of them.

The binder resin is not particularly limited, as long as it is an ingredient which assists binding of the active material with the conductive material, and binding to the current collector. Particular examples of the binder resin include polyvinylidene fluoride, polyvinyl alcohol, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene monomer terpolymer (EPDM), sulfonated EPDM, styrene butadiene rubber, fluororubber, various copolymers thereof, or the like. In general, the binder resin may be used in an amount of 1-30 wt %, or 1-10 wt %, based on 100 wt % of electrode active material layer.

According to the present disclosure, the electrode active material layer may further include at least one additive, such as an oxidation stabilizing additive, a reduction stabilizing additive, a flame retardant, a heat stabilizer, an anti-fogging agent, or the like.

In still another aspect of the present disclosure, there are provided a battery module including the battery as a unit cell, a battery pack including the battery module, and a device including the battery pack as a power source. Herein, particular examples of the device may include, but are not limited to: power tools driven by an electric motor; electric cars, including electric vehicles (EV), hybrid electric vehicles (HEV), plug-in hybrid electric vehicles (PHEV), or the like; electric carts, including electric bikes (E-bikes) and electric scooters (E-scooters); electric golf carts; electric power storage systems; or the like.

### MODE FOR DISCLOSURE

Examples will be described more fully hereinafter so that the present disclosure can be understood with ease. However, the following examples are for illustrative purposes only and the scope of the present disclosure is not limited thereto.

### Example 1

First, as ingredients of the solid electrolyte for a solid-state battery, used were lithium sulfide (Li₂S, available from Mitsuwa Chemical), diphosphorus pentasulfide (P₂S₅, available from Aldrich), tin sulfide (SnS₂, available from Japan Pure Chemical) and lithium bromide (LiBr, available from Aldrich). The ingredients were weighed and mixed with a mortar in a glove box under argon atmosphere in such a manner that the finally obtained solid electrolyte for a solid-state battery might have a composition of Li_{3.36}Sn_{0.335}P_{0.64}S_{3.9}Br_{0.1}. In this manner, a mixed powder was obtained. The resultant mixed powder was introduced to a ZrO₂ pot together with ZrO₂ balls to provide a sealed pot. The sealed pot is installed in a planetary ball mill device, ball milling was carried out at 380 rpm for 20 hours, and then the pot was opened in the glove box to recover the powder. The resultant powder was placed on an alumina boat and installed in an electric furnace, and then was fired at a firing temperature of 550° C. for 8 hours, while allowing argon gas to flow. The fired powder was pulverized with a mortar for 10 minutes to obtain a solid electrolyte for a solid-state battery.

### Example 2

A solid electrolyte for a solid-state battery was obtained in the same manner as Example 1, except that the firing temperature was 600° C.

### Example 3

A solid electrolyte for a solid-state battery was obtained in the same manner as Example 1, except that the solid electrolyte had a composition of Li_{3.40}Sn_{0.375}P_{0.60}S_{3.9}Br_{0.1}.

### Example 4

A solid electrolyte for a solid-state battery was obtained in the same manner as Example 1, except that the firing temperature was 500° C.

### Comparative Example 1

A solid electrolyte for a solid-state battery was obtained in the same manner as Example 1, except that lithium bromide was not used, and the solid electrolyte had a composition of Li_{3.33}Sn_{0.33}P_{0.67}S₄.

### Comparative Example 2

A solid electrolyte for a solid-state battery was obtained in the same manner as Example 1, except that lithium bromide was not used, germanium disulfide (GeS₂, available from Japan Pure Chemical) was used instead of tin sulfide, and the solid electrolyte had a composition of Li_{3.45}Sn_{0.45}P_{0.55}S₄.

### Example 5

To the solid electrolyte for a solid-state battery obtained from Example 1, 4 wt % of LiBr powder based on the total weight of the solid electrolyte for a solid-state battery was added, and the ingredients were mixed with a mortar for 10 minutes. In this manner, a solid electrolyte for a solid-state battery containing LiBr added thereto was obtained.

### Example 6

To the solid electrolyte for a solid-state battery obtained from Comparative Example 2, 4 wt % of LiBr powder based on the total weight of the solid electrolyte for a solid-state battery was added, and the ingredients were mixed with a mortar for 10 minutes. In this manner, a solid electrolyte for a solid-state battery containing LiBr added thereto was obtained.

[Evaluation]

Each solid electrolyte for a solid-state battery was evaluated as follows.

[XPS Analysis]

X-Ray Photoelectron Spectroscopy (XPS)

Soft X-ray was irradiated to the surface of a sample under ultrahigh vacuum, and the photoelectrons emitted from the surface were detected by an analyzer. As determined from a length (average free path) in which the photoelectrons can progress into the material of several nanometers, the detection depth of this analysis is several nanometers. The elemental information of the surface is obtained from the binding energy values of electrons restricted in the material, and information about the valance number or binding state is obtained from the energy shift of each peak. The elemental ratio (composition) can be evaluated quantitatively from the peak area ratio.

Sample

The powder of each solid electrolyte for a solid-state battery was fixed in indium foil to be used as a sample. The powder was sampled and transferred to the apparatus under argon atmosphere.

Analysis Condition

Apparatus: Quantera SXM(Ulvac-PHI)

Excited X-ray: monochromatic AlK1, 2 ray (1486.6 eV)

X-ray penetration: 200 μm

Photoelectron detection angle: 45° (slope of detector to sample surface)

Data Processing

Smoothing: 9-point smoothing

Transverse axis correction with the C1s main peak (CHx, C—C) taken as 284.6 eV.

[XRD Analysis]

Each solid electrolyte for a solid-state battery was introduced to a sealed holder in a glove box under argon gas, and X-ray diffractometry (XRD) was carried out to calculate the lattice constants and lattice volume from the diffraction pattern.

[H₂S Generation]

Each solid electrolyte for a solid-state battery (crude powder) or solid electrolyte for a solid-state battery having an average particle diameter of 10 μm or less was sealed in a plastic box together with a H₂S gas concentration analyzer, in a glove box set with a dew point of −30° C. Then, a change in H₂S level (ppm) was determined as a function of time. The amount of in H₂S generation (mL/g) per gram of the solid electrolyte for a solid-state battery was calculated from the resultant H₂S level (ppm), weight of the solid electrolyte and the volume of the plastic box.

The solid electrolyte for a solid-state battery having an average particle diameter of 10 μm or less was obtained by pulverizing each solid electrolyte for a solid-state battery with a mortar for 1 hour, followed by sieving. The average particle diameter of the solid electrolyte for a solid-state battery may be determined and evaluated by any known technology, such as scanning electron microscopy, or the like.

[Determination of Ion Conductivity]

Each solid electrolyte for a solid-state battery was weighed in a predetermined amount, a pellet-molding jig (lower jig) was assembled with a Macor tube, and then the weighed solid electrolyte was introduced to the Macor tube. Then, a pellet-molding jig (upper jig) was coupled thereto, and press molding was carried out under 5 MPa by using a monoaxial press. After that, a predetermined amount of gold powder was applied to both surfaces of the pellets, and press molding was carried out under 7.5 MPa by using a monoaxial press.

The Macor tube cell was mounted to a battery jig cell, and pressurization was carried out to 5.0 N·m by using a torque wrench to obtain an ion conductivity test cell.

The test cell was connected to an impedance analyzer, and the resistance value of the solid electrolyte pellets was measured to calculate an ion conductivity.

Each solid electrolyte for a solid-state battery was weighed in a predetermined amount, and was allowed to stand in (exposed to) a glove box set with a dew point of −45° C. for 2 hours to determine the ion conductivity.

[Manufacture of Solid-State Battery]

<Positive Electrode Mixture>

An NCM-based positive electrode active material and a powder of a solid electrolyte for a solid-state battery having an average particle diameter of 10 μm or less were weighed at a weight ratio of 70:30. Then, 5 agate balls with φ 2 mm were added to the mixture and ball milling was carried out at 140 rpm for 20 minutes to obtain a positive electrode mixture.

<Solid Electrolyte Pellets>

The resultant solid electrolyte for a solid-state battery was weighed in an amount of 80 mg, installed in a molding jig, and pressurization molding was carried out under 6 MPa for 1 minute to obtain solid electrolyte pellets.

<Positive Electrode Layer>

First, 10 mg of the positive electrode mixture was provided at one side of the solid electrolyte pellets. Then, the positive electrode-side pin of the molding jig was pressed lightly against the positive electrode mixture to make the solid electrolyte pellets flat, thereby forming a positive electrode layer.

<Solid State Battery>

An aluminum mesh and an aluminum plate were provided successively on the positive electrode layer, and pressurization was carried out under 30 MPa for 1 minute. Then, an indium foil, a lithium foil and a copper mesh were provided successively on the surface opposite to the positive electrode side of the solid electrolyte pellets, and press molding was carried out under 12 MPa for 3 seconds. After that, a positive electrode-side pin and a negative electrode-side pin were coupled to the molded product to obtain a Macor tube cell. The Macor tube cell was installed in a battery cell, and a torque of 20 N·m was applied thereto to obtain a solid-state battery. The solid-state battery had a structure of positive electrode-side pin/aluminum plate/aluminum mesh/positive electrode layer/solid electrolyte/indium foil/lithium foil/copper mesh/negative electrode-side pin. The aluminum plate and the aluminum mesh function as a positive electrode current collector, the indium foil and the lithium foil function as a negative electrode active material, and the copper mesh functions as a negative electrode current collector.

In addition, the solid electrolyte for a solid-state battery was exposed at a dew point of −45° C. for 2 hours, and was used to obtain solid electrolyte pellets. The solid electrolyte pellets were used to obtain a solid-state battery in the same manner as described above.

[Charge/Discharge Test]

The solid-state battery was used to carry out a charge/discharge test. The voltage range was 3.6-1.9 V, the charging condition was constant current (CC) (0.05 C)-constant voltage (CV) (0.01 C), and the discharging condition was CC (0.05 C). The initial charge capacity, the initial discharge capacity and the initial efficiency were obtained from the charge/discharge curve.

(Evaluation Results)

[XPS Analysis]

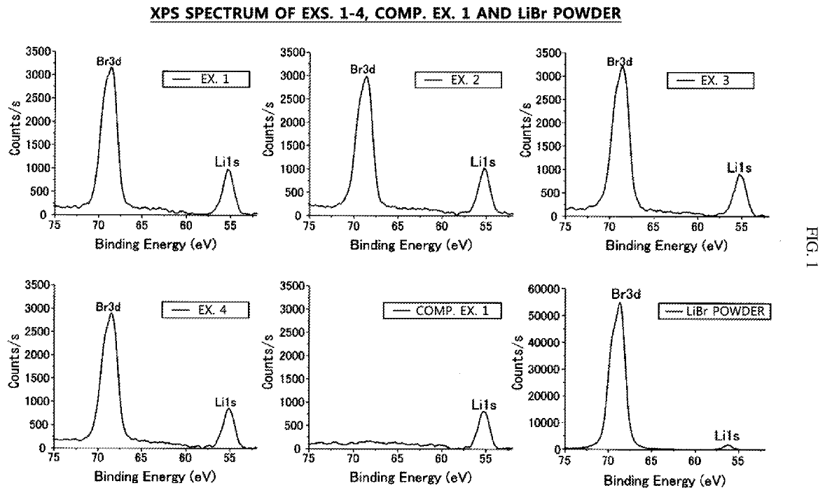

The results of XPS analysis are shown in Tables 1 and 2 and FIG. 1. FIG. 1 shows the XPS spectrum of each of Examples 1-4, Comparative Example 1 and LiBr powder. As shown in FIG. 1 and Table 1, the solid electrolyte for a solid-state battery including LiBr as an absorbent material according to each of Examples 1-4 show both peaks of Li1s and Br3d. Meanwhile, in the case of the solid electrolyte for a solid-state battery including no LiBr according to Comparative Example 1, any peak of Br3d is not present substantially. It is thought that the peak of Li1s observed in the case of Comparative Example 1 is derived from Li contained in the sulfide-based solid electrolyte.

TABLE 1

| | | | | | | | | | (After exposure |
|---|---|---|---|---|---|---|---|---|---|
| | | | | | | | | | for 60 min.) |
| | Firing | | | | | | | | (mL/g, solid |
| | temperature, | | | | | | | | electrolyte) |
| | time | | Li Peak | Br Peak | | | | | (crude powder) |
| | (° C.), | Composition of | (XPS | (XPS | Crystal Phase (XRD analysis) | | | | Dew |
| | (h) | ingredients | analysis) | analysis) | LiSnPS | Li₂SnS₃ | Li₄SnS₄ | LiBr | point −30° C. |
| Ex. 1 | 550, 8 h | Li_{3.36}Sn_{0.335}P_{0.64}S_{3.9}Br_{0.1} | ∘ | ∘ | ∘ | — | ∘ | — | 0.14 |
| Ex. 2 | 600, 8 h | Li_{3.36}Sn_{0.335}P_{0.64}S_{3.9}Br_{0.1} | ∘ | ∘ | ∘ | — | ∘ | ∘ | 0.12 |
| Ex. 3 | 550, 8 h | Li_{3.40}Sn_{0.375}P_{0.60}S_{3.9}Br_{0.1} | ∘ | ∘ | ∘ | ∘ | ∘ | ∘ | 0.12 |
| Ex. 4 | 500, 8 h | Li_{3.40}Sn_{0.375}P_{0.60}S_{3.9}Br_{0.1} | ∘ | ∘ | ∘ | ∘ | ∘ | — | 0.18 |
| Ex. 5 | — | Ex. 1 + 4% LiBr | — | — | ∘ | — | ∘ | ∘ | 0.08 |
| Ex. 6 | — | Comp. Ex. 2 + 4% LiBr | — | — | ∘ | — | — | ∘ | 0.28 |
| Comp. | 550, 8 h | Li_{3.33}Sn_{0.33}P_{0.67}S₄ | ∘ | None | ∘ | ∘ | ∘ | — | 0.33 |
| Ex. 1 | | | | | | | | | |
| Comp | 550, 8 h | Li_{3.45}Ge_{0.45}P_{0.55}S₄ | — | — | ∘ | — | — | — | 0.4 |
| Ex. 2 | | | | | | | | | |

Table 2 shows the Br3d peak count number, Br3d peak binding energy, Li1s peak count number, Li1s peak binding energy, and the count number ratio (Br3d/Li1s).

TABLE 2
Peak value and Binding Energy in XPS Spectrum

| | | Binding | | Binding | |
|---|---|---|---|---|---|
| | Br3d Peak | energy of | Li1s Peak | energy of | Br3d Peak |
| | value | Br3d peak | value | Li1s peak | value/Li1s |
| | (counts/s) | value (eV) | (counts/s) | value (eV) | Peak value |
| Ex. 1 | 3150 | 68.55 | 977 | 55.25 | 3.224 |
| Ex. 2 | 2980 | 68.56 | 1020 | 55.26 | 2.923 |
| Ex. 3 | 3201 | 68.55 | 908 | 55.25 | 3.523 |
| Ex. 4 | 2902 | 68.42 | 866 | 55.12 | 3.348 |
| Comp. Ex. 1 | (no peak) | — | 810 | 55.25 | 0.205 |
| LiBr powder | 55001 | 68.69 | 1788 | 56.19 | 30.761 |

As shown in Table 2, in the case of Examples 1-4, the binding energy of Li1s peak of Example 1 is 55.25 eV, that of Example 2 is 55.26 eV, that of Example 3 is 55.25 eV, that of Example 4 is 55.12 eV, and that of Comparative Example 1 is 55.25 eV. In addition, the binding energy of Br3d peak of Example 1 is 68.55 eV, that of Example 2 is 68.56 eV, that of Example 3 is 68.55 eV, that of Example 4 is 68.42 eV, and that of Comparative Example 1 is 68.55 eV. Meanwhile, in the case of pure LiBr powder, the binding energy of Li1s peak is 56.19 eV, and the binding energy of Br3d peak is 68.69 eV.

The binding energy of Li1s peak of LiBr contained in the solid electrolyte for a solid-state battery according to the present disclosure is reduced by 0.93-1.07 eV, as compared to the binding energy of Li1s peak of LiBr powder. The binding energy of Br3d peak of LiBr contained in the solid electrolyte for a solid-state battery according to the present disclosure is reduced by 0.13-0.27 eV, as compared to the binding energy of Br3d peak of LiBr powder. It is thought that the above results are because the presence of LiBr on the surface and/or inside the sulfide-based solid electrolyte in the solid electrolyte of the present disclosure makes the binding energy of Li1s peak and that of Br3d peak, different from the binding energy of LiBr present as a simple substance.

As shown in Table 2, the count number ratio (Br3d peak value/Li1s peak value) of Example 1 is 3.224, that of Example 2 is 2.923, that of Example 3 is 3.523, that of Example 4 is 3.348, and that of Comparative Example 1 is 0.205. It can be seen that Examples 1-4 including LiBr in the solid electrolyte for a solid-state battery shows a higher count number ratio, while Comparative Example 1 including no LiBr in the solid electrolyte for a solid-state battery substantially shows no Br3d peak detected by XPS and provides a lower count number ratio.

[XRD Analysis]

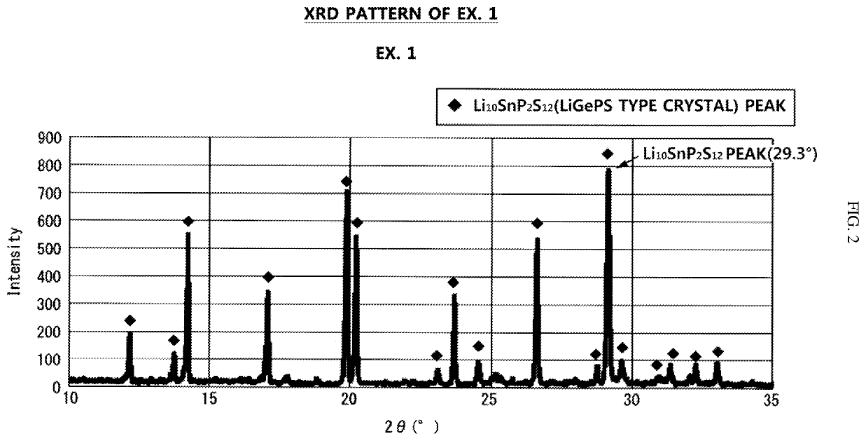

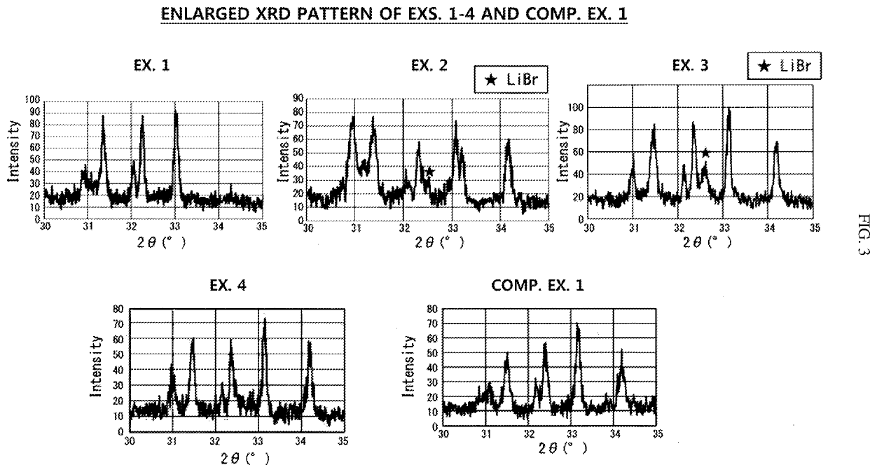

The results of XRD analysis are shown in Tables 1, 3 and 4 and FIGS. 2 and 3.

<Crystal Phase>

Table 1 shows the results of evaluation of crystal phases identified from the XRD patterns obtained by XRD analysis.

FIG. 2 illustrates the XRD pattern of Example 1 (10°≤2θ≤35°). It can be seen that a solid electrolyte for a solid-state battery including a sulfide-based solid electrolyte of Li₁₀SnP₂S₁₂ (LiGePS type crystal) having a peak at around 29.3° as a main phase is obtained.

FIG. 3 illustrates the enlarged XRD pattern (30°≤2θ≤35°) of each of Examples 1-4 and Comparative Example 1. In Examples 2 and 3, LiBr crystal phase having a peak at around 32.6° is detected. Although it is not shown, in Examples 5 and 6 including addition of LiBr, LiBr crystal phase having a peak at around 32.6° is detected. On the contrary, in Examples 1 and 4 and Comparative Example 1, no LiBr crystal phase having a peak at around 32.6° is detected. Example 1 includes firing at 550° C. in the same manner as Example 3, but no LiBr crystal phase is detected. It is thought that this is because Example 1 and Example 3 have a different composition of ingredients. In Examples 1 and 4, Li1s peak and Br3d peak are detected from the XPS analysis results, and thus it is thought that LiBr is present in the crystal lattice in the form of a solid solution, or is amorphous and present on the surface and/or inside of Li₁₀SnP₂S₁₂.

Table 3 shows the half-width of the LiBr peak obtained from the XRD pattern. Examples 2 and 3 show a half-width of LiBr peak of 0.160 and 0.21°, respectively.

Table 3 also shows the ratio of LiBr peak (32.6°) intensity/Li₁₀SnP₂S₁₂ peak (29.3°) intensity, which is the peak intensity of LiBr phase at around 32.6° based on the maximum peak intensity (see, FIG. 2) of Li₁₀SnP₂S₁₂ (LiGePS type crystal) at around 29.3°, after removing the background. Examples 2 and 3 show a ratio of LiBr peak (32.6°) intensity/Li₁₀SnP₂S₁₂ peak (29.3°) intensity of 0.079 and 0.039, respectively.

TABLE 3
LiBr Peak Half-Width and Peak Intensity Ratio of
LiBr/Li₁₀SnP₂S₁₂ (LiGePS type crystal) in Examples 1-4 and
Comparative Example 1

| | | LiBr peak (32.6°) |
|---|---|---|
| | Half-Width(°) of | intensity/Li₁₀SnP₂S₁₂ peak |
| | LiBr Peak | (29.3°) intensity, after |
| | (32.6°) | removing background |
| Example 1 | No peak | ~0 |
| Example 2 | 0.16 | 0.079 |
| Example 3 | 0.21 | 0.039 |
| Example 4 | No peak | ~0 |
| Comparative | No peak | ~0 |
| Example 1 | | |

<Lattice Constants and Lattice Volume>

Table 4 shows the lattice constants and lattice volume calculated from the XRD pattern. The lattice volume of Example 1 is 989.1 Å³, that of Example 2 is 986.2 Å³, that of Example 3 is 979.4 Å³, that of Example 4 is 978.0 Å³, and that of Comparative Example 1 is 972.9 Å³. Based on the lattice volume of Comparative Example 1 in which the solid electrolyte for a solid-state battery has a composition of Li_{3.33}Sn_{0.33}P_{0.67}S₄, Examples 1-4 have a lattice volume of 1.67%, 1.37%, 0.67% and 0.52% larger than the lattice volume of Comparative Example 1, respectively. It is thought that this is because LiBr is received in the main phase of Li₁₀SnP₂S₁₂ in the form of a solid solution by the firing (heat treatment) at a temperature close to the melting point (552° C.) of LiBr, and thus the lattice volume of the solid electrolyte for a solid-state battery is increased.

TABLE 4

| | Firing | | | | | |
|---|---|---|---|---|---|---|
| | temperature, | | | | | Lattice |
| | time (° C.), | Composition of | Lattice constant (Å) | | | volume |
| | (h) | Ingredients | a | b | c | (Å³) |
| Ex. 1 | 550, 8 h | Li_{3.36}Sn_{0.335}P_{0.64}S_{3.9}Br_{0.1} | 8.7738 | 8.7738 | 12.849 | 989.1 |
| Ex. 2 | 600, 8 h | Li_{3.36}Sn_{0.335}P_{0.64}S_{3.9}Br_{0.1} | 8.7691 | 8.7691 | 12.825 | 986.2 |
| Ex. 3 | 550, 8 h | Li_{3.40}Sn_{0.375}P_{0.60}S_{3.9}Br_{0.1} | 8.7491 | 8.7491 | 12.795 | 979.4 |
| Ex. 4 | 550, 8 h | Li_{3.40}Sn_{0.375}P_{0.60}S_{3.9}Br_{0.1} | 8.7479 | 8.7479 | 12.781 | 978 |
| Comp. | 550, 8 h | Li_{3.33}Sn_{0.33}P_{0.67}S₄ | 8.7412 | 8.7412 | 12.733 | 972.9 |
| Ex. 1 | | | | | | |

[H₂S Generation]

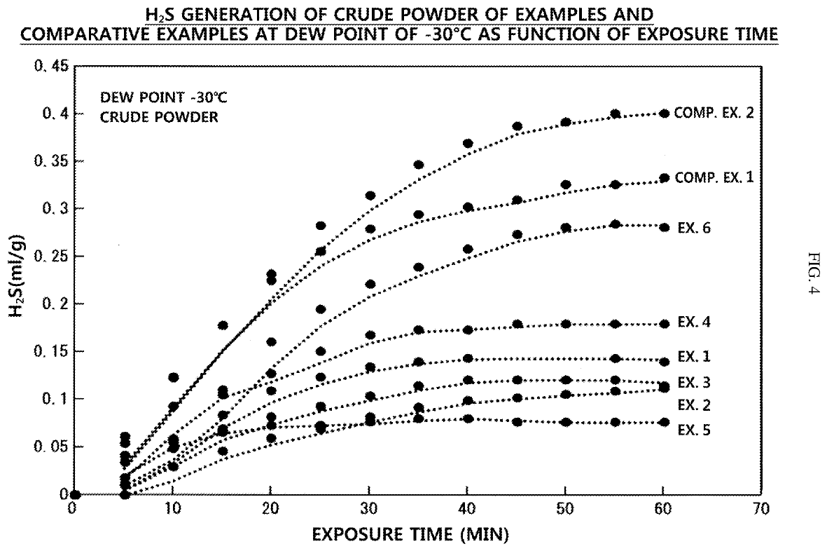

The results of H₂S generation are shown in Table 1 and FIGS. 4-6. FIG. 4 illustrates a change in generation of H₂S from the solid electrolyte for a solid-state battery (crude powder) at a dew point of −30° C. for 0-60 minutes, depending on exposure time. Table 1 shows the H₂S generation when the solid electrolyte is exposed at a dew point of −30° C. for 60 minutes. The amount of H₂S generation of Example 1 is 0.14 mL/g, that of Example 2 is 0.12 mL/g, that of Example 3 is 0.12 mL/g, that of Example 4 is 0.18 mL/g, that of Example 5 is 0.08 mL/g, that of Example 6 is 0.28 mL/g, that of Comparative Example 1 is 0.33 mL/g, and that of Comparative Example 2 is 0.40 mL/g. Examples 1-4 in which the sulfide-based solid electrolyte and absorbent material are fired can inhibit H₂S generation as compared to Comparative Examples 1 and 2 in which only the sulfide-based solid electrolyte is fired. It can be seen that the solid electrolyte for a solid-state battery according to the present disclosure can inhibit H₂S generation, when being exposed to a degree of water similar to the conventional process for manufacturing a lithium-ion battery.

It is thought that since LiBr as an absorbent material is present on the surface and/or inside of Li₁₀SnP₂S₁₂, LiBr forms hydrate with water to inhibit H₂S generation.

In addition, in the case of Example 5 in which LiBr is added subsequently to the solid electrolyte for a solid-state battery according to Example 1, it is possible to inhibit H₂S generation to a higher degree as compared to Example 1. In the case of Example 6 in which LiBr is added subsequently to the solid electrolyte for a solid-state battery according to Comparative Example 2, it is possible to inhibit H₂S generation to a higher degree as compared to Comparative Example 2. Even when the absorbent material is not received in the lattice of the sulfide-based solid electrolyte in the form of a solid solution, the effect of inhibiting H₂S generation is recognized, while the absorbent material is mixed with the solid electrolyte for a solid-state battery.

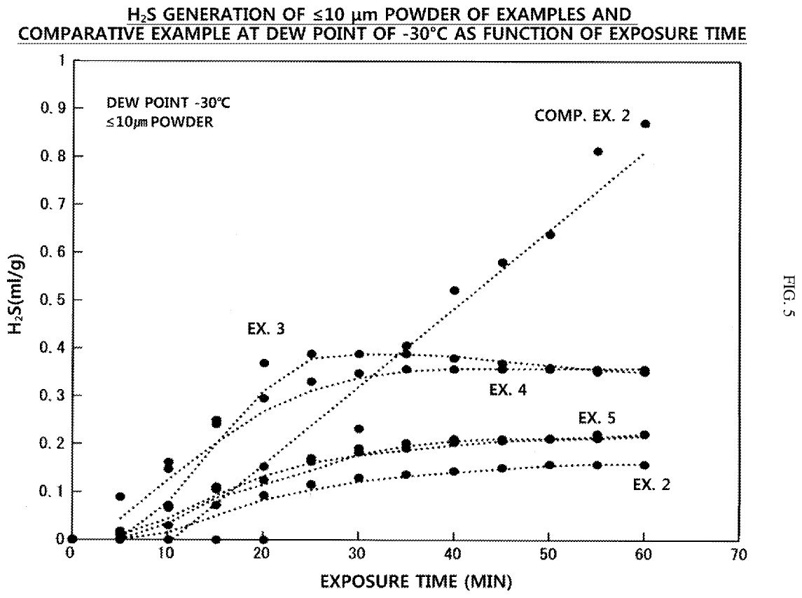

FIG. 5 illustrates a change in generation of H₂S from the solid electrolyte for a solid-state battery having an average particle diameter of 10 μm or less at a dew point of −30° C. for 0-60 minutes, depending on exposure time. When exposing the solid electrolyte for a solid-state battery at a dew point of −30° C. for 0-60 minutes, the amount of H₂S generation of Example 1 is 0.22 mL/g, that of Example 2 is 0.16 mL/g, that of Example 3 is 0.35 mL/g, that of Example 4 is 0.36 mL/g, that of Example 5 is 0.22 mL/g, and that of Comparative Example 2 is 0.87 mL/g.

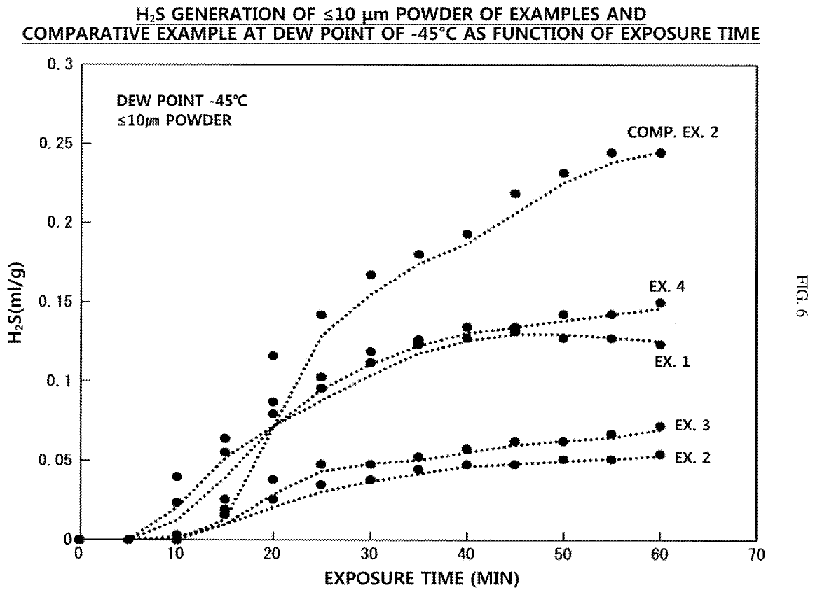

FIG. 6 illustrates a change in generation of H₂S from the solid electrolyte for a solid-state battery having an average particle diameter of 10 μm or less at a dew point of −45° C. for 0-60 minutes, depending on exposure time. When exposing the solid electrolyte for a solid-state battery at a dew point of −45° C. for 0-60 minutes, the amount of H₂S generation of Example 1 is 0.12 mL/g, that of Example 2 is 0.05 mL/g, that of Example 3 is 0.07 mL/g, that of Example 4 is 0.15 mL/g, and that of Comparative Example 2 is 0.25 mL/g.

The solid electrolyte for a solid-state battery according to the present disclosure can inhibit H₂S generation, even when it is pulverized into fine powder of 10 μm or less.

[Ion Conductivity and Retention Thereof]

The results of ion conductivity and retention thereof are shown in Table 5. Table 5 shows the initial ion conductivity, ion conductivity after the exposure at a dew point of −45° C. for 2 hours, and ion conductivity retention of the solid electrolyte pellets formed by using the solid electrolyte for a solid-state battery. The ion conductivity retention is calculated by the mathematical formula of (Ion conductivity after the exposure at a dew point of −45° C. for 2 hours)/(Initial ion conductivity)×100(%). The ion conductivity retention of Example 1 is 95.2%, that of Example 2 is 97.7%, that of Example 3 is 90.6%, that of Example 4 is 83.2%, that of Example 5 is 97.2%, that of Example 6 is 95.8%, that of Comparative Example 1 is 84.2%, and that of Comparative Example 2 is 89.5%. Examples 1-3, 5 and 6 shows a higher ion conductivity retention as compared to Comparative Examples 1 and 2. It can be seen that the solid electrolyte for a solid-state battery including an absorbent material according to the present disclosure maintains a high level of ion conductivity, even when being exposed to water.

TABLE 5

| | Ion conductivity (σ 298K) (S/cm) | | Ion conductivity |
|---|---|---|---|
| | Initial | After exposure for 2 hr | retention (%) |
| Example 1 | 5.80 × 10⁻³ | 5.53 × 10⁻³ | 95.2 |
| Example 2 | 2.61 × 10⁻³ | 2.55 × 10⁻³ | 97.7 |
| Example 3 | 5.43 × 10⁻³ | 4.92 × 10⁻³ | 90.6 |
| Example 4 | 5.53 × 10⁻³ | 4.60 × 10⁻³ | 83.2 |
| Example 5 | 3.20 × 10⁻³ | 3.11 × 10⁻³ | 97.2 |
| Example 6 | 5.23 × 10⁻³ | 5.01 × 10⁻³ | 95.8 |
| Comparative | 5.58 × 10⁻³ | 4.70 × 10⁻³ | 84.2 |
| Example 1 | | | |
| Comparative | 9.85 × 10⁻³ | 8.82 × 10⁻³ | 89.5 |
| Example 2 | | | |

[Charge/Discharge Test]

The charge/discharge test results are shown in Table 6. Table 6 shows the initial charge capacity, initial discharge capacity and initial efficiency of the solid-state battery according to Examples 1 and 2. Example 1 shows an initial charge capacity of 177.6 mAh/g, an initial discharge capacity of 166.1 mAh/g and an initial efficiency of 93.5%. Example 2 shows an initial charge capacity of 182.0 mAh/g, an initial discharge capacity of 166.0 mAh/g and an initial efficiency of 91.2%.

In addition, in the case of the solid-state battery using the solid electrolyte obtained by exposing each solid electrolyte at a dew point of −45° C. for 2 hours, Example 1 shows an initial charge capacity of 180.9 mAh/g, an initial discharge capacity of 167.9 mAh/g and an initial efficiency of 92.8%. Example 2 shows an initial charge capacity of 177.9 mAh/g, an initial discharge capacity of 165.8 mAh/g and an initial efficiency of 93.2%.

TABLE 6
Initial Charge Capacity, Initial Discharge Capacity and
Initial Efficiency of Solid-State Battery

| | Initial charge | Initial discharge | Initial |
|---|---|---|---|
| | capacity | capacity | Efficiency |
| | (mAh/g) | (mAh/g) | (%) |
| Example 1 | 177.6 | 166.1 | 93.5 |
| Example 2 | 182 | 166 | 91.2 |
| Example 1 (after | 180.9 | 167.9 | 92.8 |
| exposure at −45° C. | | | |
| for 2 hr) | | | |
| Example 2 (after | 177.9 | 165.8 | 93.2 |
| exposure at −45° C. | | | |
| for 2 hr) | | | |

The solid-state battery using the solid electrolyte for a solid-state battery according to the present disclosure can be charged/discharge with no problem and shows excellent battery characteristics. Even after the solid electrolyte for a solid-state battery is exposed at a dew point of −45° C. for 2 hours, the solid-state battery can retain a high initial charge capacity, initial discharge capacity and initial efficiency.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

1. A solid electrolyte for a solid-state battery, comprising:
a sulfide-based solid electrolyte; and
a LiBr-containing absorbent material,
wherein a binding energy of Li1s shows a peak observed at 54.2-56.1 eV, and a binding energy of Br3d shows a peak observed at 67.5-69.5 eV, as determined by X-ray photoelectron spectroscopy (XPS).

2. The solid electrolyte for a solid-state battery according to claim 1, wherein a ratio of a peak count number of Br3d to a peak count number of Li1s (Br3d peak count number/Li1s peak count number) is 0.3 or more.

3. The solid electrolyte for a solid-state battery according to claim 1, wherein the sulfide-based solid electrolyte has a LiGePS type crystal structure.

4. The solid electrolyte for a solid-state battery according to claim 1, wherein a ratio of an intensity of a peak of LiBr present at 2θ=32.6° to an intensity of a peak of LiGePS type crystal present at 2θ=29.3° (LiBr peak (2θ=32.6°) intensity/LiGePS type crystal peak (2θ=29.3°) intensity) is 0.02 or more, as determined by XRD.

5. The solid electrolyte for a solid-state battery according to claim 1, wherein a lattice volume (V) of the solid electrolyte for a solid-state battery and a lattice volume (V₀) of the sulfide-based solid electrolyte satisfy a relationship of 0.5≤{(V−V₀)/V₀}×100.

6. A method for preparing a solid electrolyte for a solid-state battery, comprising the steps of:
mixing a sulfide-based solid electrolyte with an absorbent material to obtain a mixture; and
heat treating the mixture,
wherein a heat treatment temperature (T[° C.]) and a melting point (Tₘ[° C.]) of the absorbent material satisfy a relationship of T≥Tₘ−60.

7. The method for preparing a solid electrolyte for a solid-state battery according to claim 6, wherein the absorbent material comprises LiBr.

8. The method for preparing a solid electrolyte for a solid-state battery according to claim 6, further comprising:
a step of adding the absorbent material after the heat treatment step.
